(19) United States
(12) Patent Application Publication
(10) Pub. No.: US 2025/0033992 A1
(43) Pub. Date: Jan. 30, 2025

(54) METHOD OF MAKING NANOSHEETS

(71) Applicant: QinetiQ Limited, Hampshire (GB)

(72) Inventor: Charles John Michael FOOTER, Hampshire (GB)

(21) Appl. No.: 18/704,536

(22) PCT Filed: Oct. 5, 2022
(86) PCT No.: PCT/EP2022/077671

§ 371 Date: Apr. 25, 2024

(30) Foreign Application Priority Data
Oct. 29, 2021 (GB) 2115555.1

(51) Int. Cl. C01G 39/06; C01B 32/19

(52) U.S. Cl. CPC C01G 39/06; C01B 32/19; C01P 2002/01; C01P 2004/04; C01P 2004/24; C01P 2004/51

(57) ABSTRACT

A method of making nanosheets, the method comprising: providing a mixture comprising a bulk material and a solvent mixture, the solvent mixture comprising: a transition metal nitrate; an acid; a non-polar solvent; and a dispersant; and the method further comprising treating the mixture with an ultrasound treatment to exfoliate nanosheets from the bulk material.

### CROSS REFERENCE TO RELATED APPLICATION(S)

This application is a national phase filing under 35 C.F.R. § 371 of and claims priority to PCT Patent Application No. PCT/EP2022/077671, filed on Oct. 5, 2022, which claims the priority benefit under 35 U.S.C. § 119 of British Patent Application No. 2115555.1, filed on Oct. 29, 2021, the contents of each of which are hereby incorporated by reference in their entireties.

### BACKGROUND TO THE INVENTION

Nanosheets, also referred to as two-dimensional materials or layered nanostructures, find important uses in materials applications such as graphene and transition metal di-chalcogenides (DTCs or MX₂S) including MoS₂. Ideally such nanostructures are flakes having the thickness of a single atomic layer across the majority of their area.

A typical method for forming nanosheets involves lattice ‘unzipping’ across the basal plane to remove layers of the crystal structure, for example by chemical etching, which is followed by mechanical exfoliation to remove the layers from the bulk material.

One method for producing nanosheets is an intercalation method. An initial bulk material (e.g. bulk MoS₂) undergoes intercalation with a reactive ion species (e.g. Li) to form an intercalated phase (e.g. LiₓMoS₂). This disrupts interlayer attraction so that the layers can be exfoliated off, before being returned to the original material by washing to remove the intercalated ions.

In another method, nanosheets are exfoliated off the bulk material by sonication in polar solvents such ad N-methylpyrrolidone (NMP). The sonication process must take place over long periods of time (for example 200 hours for a yield of 40%) and at high energy and high frequency.

However, producing high-quality structures (where all structures are the thickness of a single atomic layer across the majority of the flake), is very difficult. It is particularly difficult to produce flakes of large diameter that are single layer thickness. As a result, a large proportion of nanosheets that are available on the market are of poor quality, with an undesirably large thickness. In particular many products are ‘few layer’ rather than single layer structures, which do not produce the same advantageous properties.

It is against this background that the invention has been devised.

### STATEMENTS OF THE INVENTION

From a first aspect the invention resides in a method of making nanosheets, the method comprising:
providing a mixture comprising a bulk material and a solvent mixture, the solvent mixture comprising:
   a transition metal nitrate;
   an acid;
   a non-polar solvent; and
   a dispersant; and
   treating the mixture with an ultrasound treatment to exfoliate nanosheets from the bulk material.

The dispersant may comprise a first dispersant comprising an emulsifier and a second dispersant comprising a lubricant.

The solvent may comprise up to 1 wt % dispersant.

The transition metal nitrate preferably comprises a transition metal having an atomic number between 11 and 30. The transition metal nitrate may for example comprise a zinc nitrate, such as ZnNO₃·9H₂O.

The transition metal nitrate content of the solution may be between approximately 10 g per 220 ml of solution and approximately 100 g per 130 ml of solution.

The solvent mixture may further comprise deionised water.

The solvent mixture may comprise between approximately 7% and approximately 45% non-polar solvent by volume. The non-polar solvent is preferably isopropanol.

The acid is preferably hydrochloric acid.

A ratio of bulk material to solvent mixture by weight is up to approximately 1:2.

The ultrasound treatment may be carried out a frequency of between 10 kHz and 100 kHz, and preferably between 30 kHz and 50 KHz.

The ultrasound treatment may be carried out for a time period that is between approximately 2 minutes and 5 hours, and is preferably 1 hour or less.

The bulk material may comprise carbon, a transition metal di-chalcogenide (such as MoS₂ or WS₂), Gr, GO, Si, SiO₂, B₄C, MoSe₂, MoTe₂, NiTe₂, NbSe₂, WC, HbN, SiN, or SiC.

The invention also extends to a solvent mixture for use in making nanosheets, the solvent mixture comprising:
a non-polar solvent;
a dispersant;
a transition metal nitrate; and
an acid.

The invention extends further to nanosheets made using the methods described above and/or the solvents described above.

### BRIEF DESCRIPTION OF THE DRAWINGS

By way of example, embodiments of the invention will be described with reference to the accompanying drawings in which:

FIG. 1 is a Tunnelling Electron Microscopy (TEM) image of a high-quality MoS₂ nanosheet produced according to a method of invention; and

FIG. 2 is a further Tunnelling Electron Microscopy (TEM) image of a high-quality MoS₂ nanosheet produced according to a method of invention.

FIGS. 3A to 3D show size distribution plots (Volume density (%) vs Size classes (microns)) of nanosheets produced substantially according to the method of Example 1, but with some parameters of the solution being varied.

FIGS. 4A to 4D show size distribution plots (Volume density (%) vs Size classes (microns)) of nanosheets produced substantially according to the method of Example 2, but with some parameters of the solution being varied.

### DETAILED DESCRIPTION

The invention lies in a method for producing nanosheets of particularly high quality.

A nanosheet in this case refers to a material that comprises a single layer of atomic thickness, across the majority of the material. Some small regions of the material may be of greater thickness, but the majority of the material is of single-layer thickness.

The material may be any suitable material that is capable of forming a nanosheet. Examples include but are not limited to graphene, transition metal di-chalcogenides (DTCs) including MoS₂ and WS₂. Other materials include Gr, GO, Si, SiO₂, B₄C, MoSe₂, MoTe₂, NiTe₂, NbSe₂, WC, HbN, SIN, SiC.

According to the method, the bulk material powder is dissolved in a novel solvent mixture that comprises at least isopropanol, a salt in the form of a transition metal nitrate, and a dispersing agent. This novel solvent mixture allows careful control of the lattice unzipping process. After unzipping, nanosheets can be removed from the bulk material with ultrasound treatment for a at low frequencies, providing a high yield and high-quality nanosheets.

Considering the components of the solvent mixture in more detail, the mixture comprises the following components:
Deionised water
A non-polar solvent
Transition metal nitrate salt
Dispersant
Acid, such as hydrochloric acid

The transition metal nitrate salt preferably comprises a transition metal having an atomic number greater than 11 and less than 30. In one preferred example the transition metal nitrate salt comprises a zinc nitrate, and is for example ZnNO₃·9H₂O.

The acid is preferably hydrochloric acid, though other suitable acids may be used.

The dispersant preferably comprises a first dispersant that acts as an emulisifier and a second dispersant that acts as a lubricant. The first dispersant may be for example Dispersex GA 40, commercially available from BASF®. The second dispersant may be for example a t-Octylphenoxypolyethoxyethanol, Polyethylene glycol tert-octylphenyl ether, such as Triton™ X, which is commercially available from Sigma Aldrich®. The dispersant aids in the exfoliation process by encouraging the intercalated layers to separate from each other. The dispersants also guard against re-agglomeration of the nanosheets after exfoliation. The dispersants may comprise up to approximately 1 wt % of the solvent mixture.

The non-polar solvent may be any suitable non-polar solvent such as, for example, isopropanol. The ratio of non-polar solvent to deionised water in the solvent is preferably approximately 1:5.

The bulk material is provided in powder form. The particle size of the powder is selected to reflect the desired size of the nanosheets. For example, if 2 micron nanosheets are required, a powder size of at least 2 microns will be selected.

To use the solvent to make nanosheets from bulk material, the bulk material is first added to the deionised water, and then the remaining components of the solvent mixture are added. The mixture is then subjected to the ultrasound treatment.

The transition metal nitrate salt and the hydrochloric acid carry out the lattice unzipping by etching the bulk material along lattice planes to unzip the layers. Once etching has taken place, the transition metal ions from the transition metal nitrate salt intercalate into the layers, enlarging the interlayer space. Gas bubbles of NOCl and Cl₂ (produced by reaction between the HCl and the nitrate) can infiltrate the spaces between the layers.

Without wishing to be bound by theory, the inventors believe that large transition metal of atomic number greater than 11 are beneficial because the large size of the ion results in a larger gap between the atomic layers as a result of the intercalation.

Because of the effectiveness of the solvent, the ultrasound treatment can be carried out at particularly low frequency, for example 40 kHz. The ultrasound treatment can also be particularly short, for example only 15 minutes.

Ultrasound treatment may be carried out using any suitable ultrasound device, such as for example at ultrasound bath RS pro 6.5L. Suitable frequencies are 10 kHz-100 KHz. A range of 30 kHz to 50 kHz is most preferable to balance the need for sufficiently high frequency to cause exfoliation, but sufficiently low frequency to avoid breaking the nanosheets into smaller pieces.

The ultrasound treatment may be carried out for any suitable period, but is preferably a period of between approximately 2 minutes and 5 hours, depending on the material of the nanosheets, and the volume of material undergoing treatment. Preferably the treatment time is one hour or less. This relatively short treatment time allows a high processing rate, and hence efficient production of the nanosheets.

The ultrasound treatment causes the nanosheets to separate from the bulk material. The dispersant assists with exfoliation of the nanoflakes, and also prevent re-agglomeration of the flakes once separated.

Because the ultrasound frequency is low, the energy imparted by the ultrasound treatment is also low. This is particularly advantageous as it guards against the nanosheets being broken up by the exfoliation process, meaning that large flakes of material can be maintained. In some cases smaller nanosheets may be created alongside the larger nanosheets, but large high-quality nanosheets will still be created.

The separated nanosheets float to the top of the mixture. The dispersants help to create a oil-slick like consistency on the top of the mixture, providing a top slurry comprising the nanosheet dispersion. When the ultrasound treatment is complete, the top slurry can be easily removed from the remaining solvent by simply pouring the top slurry off into a separate container, or by using a separation funnel.

If the process has produced flakes of different sizes (this may happen for example when producing graphene nanosheets), the different sized flakes can be separated by centrifuging.

The nanosheet material may be kept as a dispersion, or it may be dried to form a powder as required.

The resulting nanosheets are of particularly high quality, being of large diameter and single atomic layer across the majority of the material. The process has also been found to generate high yields of between 73% and 81%.

### EXAMPLES

### Example 1—MoS₂ Nanosheets

Bulk material: 40 g MoS₂ as 4 micron powder

### Solvent Components:

| Component | Amount | |
|---|---|---|
| Deionised water | 100 | ml |
| Transition metal nitrate salt: ZnNO₃•9H₂O | 25 | g |
| Dispersant 1: Dispersex | 0.3 | g |
| Dispersant 2: Triton ™ X | 0.1 | g |
| HCl - 5 Mol | 20 | ml |
| Isopropanol | 20 | ml |

The bulk material was first dissolved in 100 ml of deionised water. Then the nitrate salt was added, followed by the dispersants. HCl was added and finally the isopropanol.

The mixture was subject to the following ultrasound treatment:
Ultrasound equipment: RS pro 6.5L
Frequency: 40 kHz
Time: 15 minutes

During the ultrasound treatment, the nanosheets rise to the top of the mixture to form a slurry. The slurry is easily removed (either simply by pouring, or using a separating funnel). Centrifuging can also be used to separate the nanosheets from any un-zipped material. The material can be kept in dispersion form, or dried into a powder form as necessary.

The yield was found to be approximately 90%. The remainder was un-zipped or partially-zipped material.

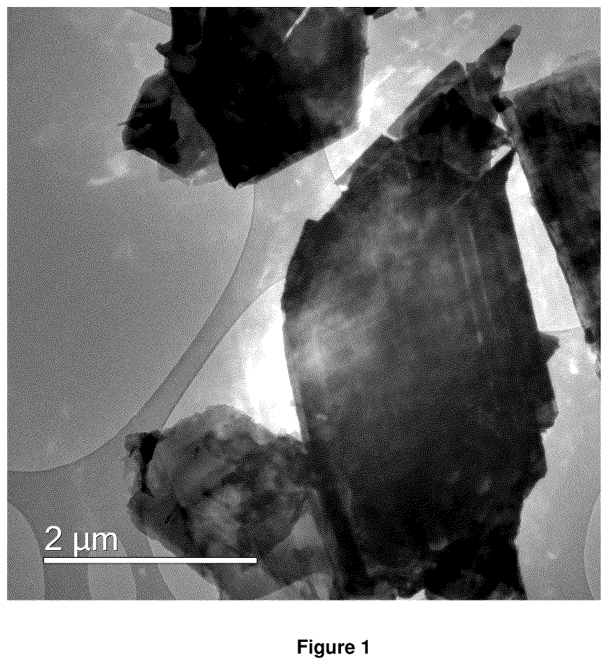

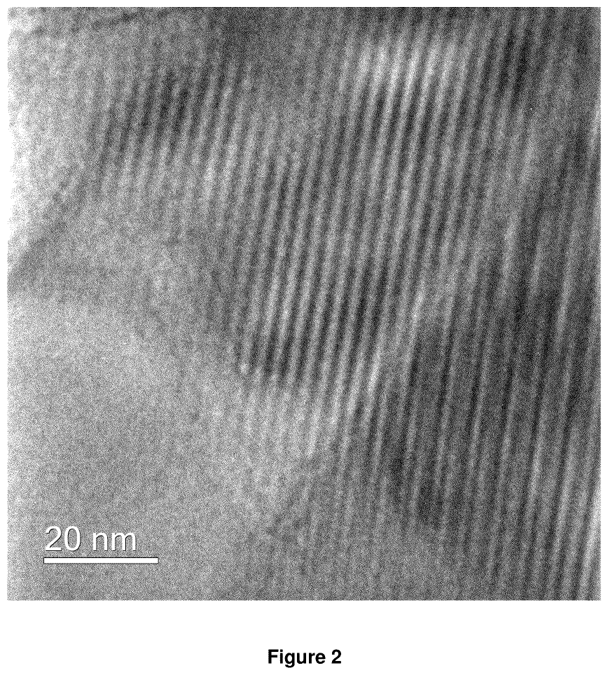

The resulting nanosheets were found to be large, and of high quality, as can be seen in FIGS. 1 and 2, which are TEM images of flakes produced according to this example.

Optical transmittance measurement showed transmittance of 93.5% and 514 nm. When the nanosheets were layered on silicon or graphene they displayed dielectric switching, which indicates that the layers must be single layers.

### Example 2—Comparison of Parameters for MoS₂ Nanosheets

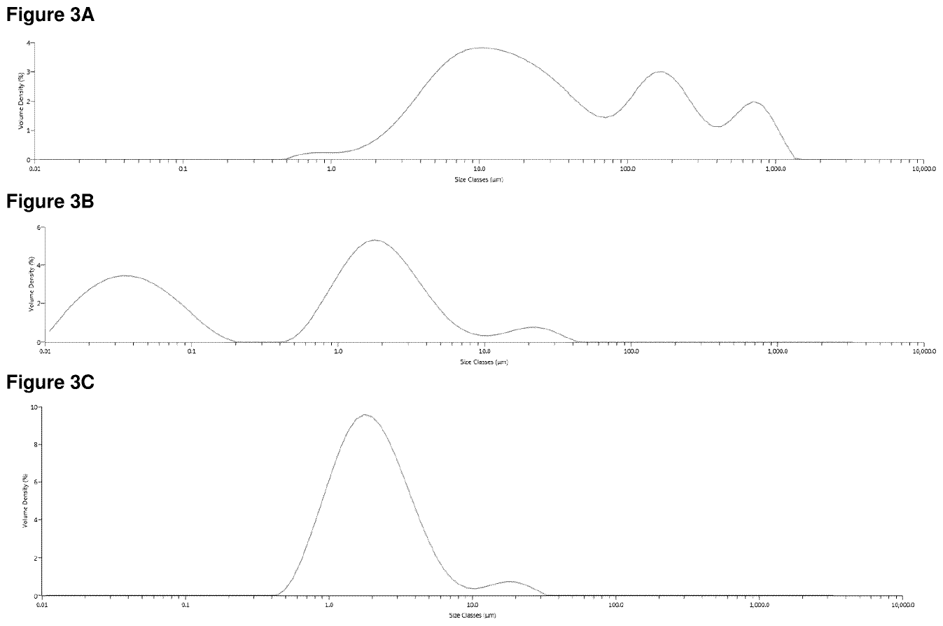

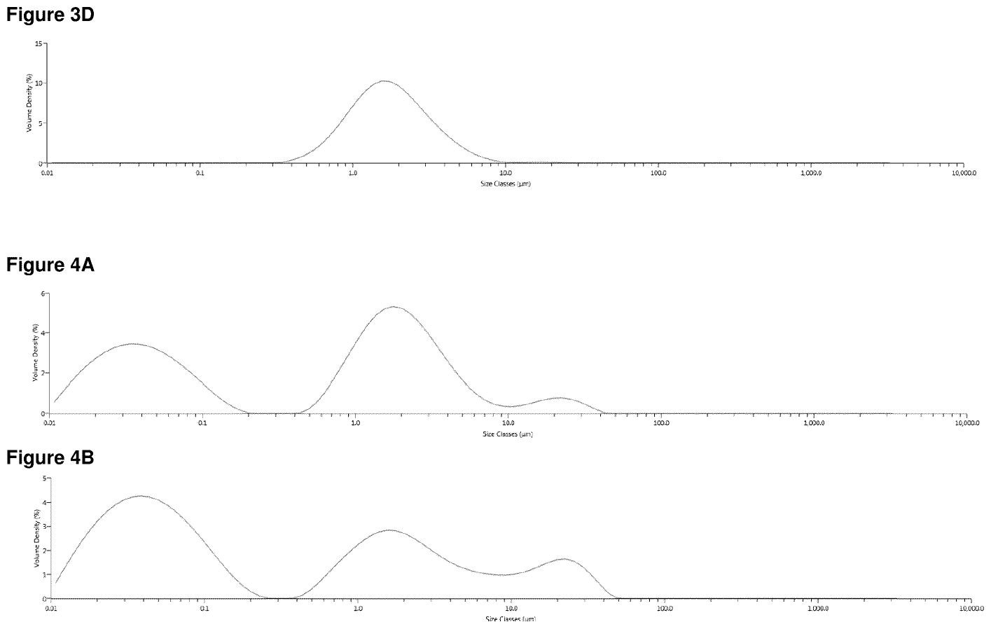

FIGS. 3A to 3D show size distribution plots (Volume density (%) vs Size classes (microns)) of nanosheets produced substantially according to the method of Example 1, but with some parameters of the solution being varied.

FIG. 3A shows the size distribution plot for the MoS₂ particles that were used as bulk material for the process.

FIG. 3B shows the size distribution plot for the product produced by the method of Example 1, but with no dispersant included, and with no solvent mixture. This plot shows a wide variety of size of the resulting material, with a larger proportion being under 1 micron.

FIG. 3C shows the size distribution plot for the product produced by the method of Example 1, but with only a single dispersant included, instead of both dispersants. This plot shows a more uniform size distribution than FIG. 3B, indicating the significant improvement achieved by the solvent mix.

FIG. 3D shows the size distribution plot for the product produced by the method of Example 1, i.e. with the solvent mix and both dispersants. The plot shows a single peak, with the majority above 1 micron, indicating a high degree of uniformity in the size of the resulting nanosheets.

### Example 3—Graphene Nanosheets

Bulk material: 14 g carbon black as 15 micron powder

### Solvent Components:

| Component | Amount | |
|---|---|---|
| Deionised water | 100 | ml |
| Transition metal nitrate salt: ZnNO₃•9H₂O | 25 | g |
| Dispersant 1: Dispersex | 0.3 | g |
| Dispersant 2: Triton ™ X | 0.5 | g |
| HCl - 5 Mol | 20 | ml |
| Isopropanol | 20 | ml |

The bulk material was first dissolved in 100 ml of deionised water. Then the nitrate salt was added, followed by the dispersants. HCl was added and finally the isopropanol.

The mixture was subject to the following ultrasound treatment:
Ultrasound equipment: RS pro 6.5L
Frequency: 40 kHz
Time: 60 minutes

During the ultrasound treatment, the nanosheets rise to the top of the mixture to form a slurry. The slurry is easily removed (either simply by pouring, or using a separating funnel).

A mixture of large flakes (10 micron diameter) and small flakes are formed. These can be separated by centrifuge.

The yield was found to be between 73% and 81%. The remainder was un-zipped or partially-zipped material.

The material can be kept in dispersion form, or dried into a powder form as necessary.

The resulting nanosheets were found to be of high quality. Optical transmittance measurement showed transmittance of 97.2% and 514 nm which is accepted as indicating single layer graphene.

### Example 4—Comparison of Parameters for Graphene Nanosheets

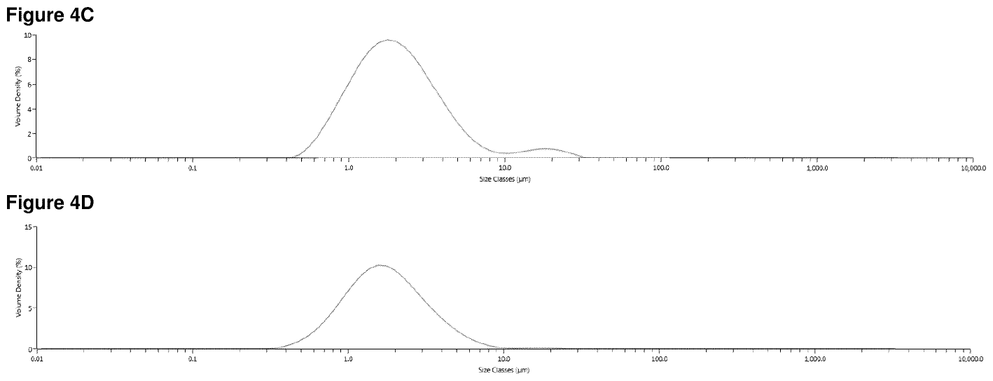

FIGS. 4A to 4D show size distribution plots (Volume density (%) vs Size classes (microns)) of nanosheets produced substantially according to the method of Example 2, but with some parameters of the solution being varied.

FIG. 4A shows the size distribution plot for the product produced by the method of Example 3, but with no dispersant included, and with no solvent mixture. This plot shows a wide variety of size of the resulting material, with the majority being under 1 micron.

FIG. 4B shows the size distribution plot for the product produced by the method of Example 3, but with no dispersant included, and with a solvent mixture comprising only isoproponal and water (i.e. omitting a transition metal nitrate salt and an acid). This plot shows a slight increase in particles having a size over 1 micron compared to FIG. 4A, but still shows a wide variety of size of the resulting material, with the majority being under 1 micron.

FIG. 4C shows the size distribution plot for the product produced by the method of Example 3, but with only a single dispersant included, instead of both dispersants. This plot shows a more uniform size distribution than FIG. 4A or FIG. 4B, indicating the significant improvement achieved by the solvent mix.

FIG. 4D shows the size distribution plot for the product produced by the method of Example 3, i.e. with the solvent mix and both dispersants. The plot shows a single peak, with the majority above 1 micron, indicating a high degree of uniformity in the size of the resulting nanosheets.

1. A method of making nanosheets, the method comprising:
providing a mixture comprising a bulk material and a solvent mixture, the solvent mixture comprising:
a transition metal nitrate;
an acid;
a non-polar solvent; and
a dispersant; and
treating the mixture with an ultrasound treatment to exfoliate nanosheets from the bulk material.

2. The method of claim 1, wherein the dispersant comprises a first dispersant comprising an emulsifier and a second dispersant comprising a lubricant.

3. The method of claim 1, wherein the solvent comprises up to 1 wt % dispersant.

4. The method of claim 1 wherein the transition metal nitrate comprises a transition metal having an atomic number between 11 and 30.

5. The method of claim 4, wherein the transition metal nitrate comprises ZnNO₃·9H₂O.

6. The method of claim 1, wherein the transition metal nitrate content of the solution is between 10 g per 220 ml and 100 g per 130 ml.

7. The method of claim 1, wherein the solvent mixture further comprises deionised water.

8. The method of claim 1, wherein the solvent mixture comprises between 7% and 45% non-polar solvent by volume.

9. The method of claim 1, wherein the non-polar solvent is isopropanol.

10. The method of claim 1, wherein a ratio of bulk material to solvent mixture by weight is up to 1:2.

11. The method of claim 1, wherein the acid is hydrochloric acid.

12. The method of claim 1, wherein the ultrasound treatment is carried out at a frequency of between 10 kHz and 100 kHz.

13. The method of claim 1, wherein the ultrasound treatment is carried out for a time period that is between 2 minutes and 5 hours.

14. The method of claim 1, wherein the bulk material comprises at least one of carbon, a transition metal di-chalcogenide, Gr, GO, Si, SiO₂, B₄C, MoSe₂, MoTe₂, NiTe₂, NbSe₂, WC, HbN, SiN, and SiC.

15. A solvent mixture for use in making nanosheets, the solvent mixture comprising:
a non-polar solvent;
a dispersant;
a transition metal nitrate; and
an acid.

16. The method of claim 2 wherein the solvent mixture comprises up to 1 wt % dispersant.

17. The method of claim 1 wherein the ultrasound treatment is carried out at a frequency of between 30 kHz and 50 kHz.

18. The method of claim 16 wherein the transition metal di-chalcogenide is at least one of MoS₂ and WS₂.

19. A nanosheet prepared by the method of claim 2.

20. A nanosheet prepared by the method of claim 2 wherein the nanosheet is one of a graphene nanosheet and a MoS₂ nanosheet.
